(19) United States
(12) Patent Application Publication
(10) Pub. No.: US 2010/0224756 A1
(43) Pub. Date: Sep. 9, 2010

(54) MOULDING MATERIAL MIXTURE CONTAINING CARBOHYDRATES

(75) Inventors: Jens Muller, Haan (DE); Diether Koch, Mettmann (DE); Marcus Frohn, Dormagen (DE); Jorg Korschgen, Koln (DE); Stefan Schreckenberg, Hilden (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: ASHLAND-SUDCHEMIE-KERNFEST GMBH, Hilden (DE)

(21) Appl. No.: 12/445,956

(22) PCT Filed: Oct. 19, 2007
(86) PCT No.: PCT/EP2007/009108

§ 371 Date: May 26, 2010

(30) Foreign Application Priority Data
Oct. 19, 2006 (DE) 102006049379.6
Dec. 28, 2006 (DE) 102006061876.9

(51) Int. Cl. B22C 9/02; B22C 1/18; B22C 1/26; C04B 35/48; C04B 35/10; C04B 35/14; C04B 35/16; C04B 35/52; C04B 35/04

(52) U.S. Cl. 249/117; 164/528; 501/103; 501/127; 501/133; 501/112; 501/99; 501/122

(57) ABSTRACT

The invention relates to a molding material mixture for production of casting molds for metalworking, to a process for producing casting molds, to casting molds obtained by the process and to the use thereof. For the production of casting molds, a refractory molding matrix and a waterglass-based binder are used. The binder has been admixed with a proportion of a particulate metal oxide which is selected from the group of silicon dioxide, aluminum oxide, titanium oxide and zinc oxide, particular preference being given to using synthetic amorphous silicon dioxide. The molding material mixture comprises a carbohydrate as a further essential constituent. The addition of carbohydrates allows the mechanical strength of casting molds and the surface quality of the casting to be improved.

The invention relates to a molding material mixture for production of casting molds for metalworking, which comprises at least one free-flowing refractory molding matrix, a waterglass-based binder, and a proportion of a particulate metal oxide which is selected from the group of silicon dioxide, aluminum oxide, titanium oxide and zinc oxide. The invention further relates to a process for producing casting molds for metalworking using the molding material mixture and to a casting mold obtained by the process.

Casting molds for the production of metal bodies are produced essentially in two versions. A first group is that of the so-called cores or molds. The casting mold is assembled from these, and essentially constitutes the negative form of the casting to be produced. A second group is that of hollow bodies, so-called feeders, which act as a balancing reservoir. These take up liquid metal, while appropriate measures ensure that the metal remains longer in the liquid phase than the metal present in the casting mold which constitutes the negative mold. When the metal solidifies in the negative mold, further liquid metal can flow from the balancing reservoir in order to balance the volume contraction which ocurrs as the metal solidifies.

Casting molds consist of a refractory material, for example quartz sand, whose grains, after demolding from the casting mold, are bound by a suitable binder in order to ensure sufficient mechanical strength of the casting mold. For the production of casting molds, a refractory molding matrix which has been treated with a suitable binder is thus used. The refractory molding matrix is preferably in a free-flowing form, such that it can be introduced into a suitable cavity and compacted there. The binder generates firm cohesion between the particles of the molding matrix, such that the casting mold receives the required mechanical stability.

Casting molds have to meet various demands. In the course of the casting operation itself, they must first have sufficient stability and thermal stability to be able to absorb the liquid metal into the hollow mold formed from one or more casting molds/mold parts. After the solidification operation has commenced, the mechanical stability of the casting mold is ensured by a solidified metal layer which forms along the walls of the cavity. The material of the casting mold must then decompose under the influence of the heat released from the metal in such a way that it loses its mechanical stability, i.e. the coherence between individual particles of the refractory material is eliminated. This is achieved by virtue, for example, of the binder decomposing under the action of heat. After cooling, the solidified casting is shaken, and in the ideal case the material of the casting molds decomposes again to a fine sand, which can be poured out of the cavities of the metal mold.

To produce the casting molds, it is possible to use either organic or inorganic binders, each of which can be hardened by cold or hot methods. Cold methods refer to methods which are performed essentially at room temperature without heating the casting mold. The hardening usually proceeds through a chemical reaction which is triggered, for example, by passing a gas as a catalyst through the mold to be hardened. In hot methods, the molding material mixture, after the molding, is heated to a sufficiently hot temperature to, for example, drive out the solvent present in the binder or to initiate a chemical reaction by which the binder is hardened, for example through crosslinking.

At present, those organic binders in which the hardening reaction is accelerated by a gaseous catalyst or which are hardened by reaction with a gaseous hardener are in many cases used for the production of casting molds. These methods are referred to as “cold box” methods.

One example of the production of casting molds using organic binders is the so-called Ashland cold box method. This involves a two-component system. The first component consists of a solution of a polyol, usually a phenol resin. The second component is the solution of a polyisocyanate. For instance, according to U.S. Pat. No. 3,409,579 A, the two components of the polyurethane binder are reacted by, after the molding, passing a gaseous tertiary amine through the mixture of molding matrix and binder. The hardening reaction of polyurethane binders is a polyaddition, i.e. a reaction without elimination of by-products, for example water. The further advantages of this cold box method include good productivity, measurement accuracy of the casting molds and good technical properties, such as the strength of the casting molds, the processing time of the mixture of molding matrix and binder, etc.

The hot-hardening organic methods include the hot box method based on phenol or furan resins, the warm box method based on furan resins and the Croning method based on phenol-novolac resins. In the hot box method and in the warm box method, liquid resins are processed with a latent hardener which only becomes effective at elevated temperature to give a molding material mixture. In the Croning method, molding matrices such as quartz, chrome ore sands, zirconium sands, etc. are enveloped at a temperature of approx. 100 to 160° C. with a phenol-novolac resin liquid at this temperature. As a rectant for the later hardening, hexamethylenetetramine is added. In the abovementioned hot-hardening technologies, molding and hardening take place in heatable molds which are heated to a temperature of up to 300° C.

Irrespective of the hardening mechanism, what is common to all organic systems is that they decompose thermally when the liquid metal is introduced into the casting mold and as they do so can release harmful substances, for example benzene, toluene, xylenes, phenol, formaldehyde, and higher cracking products, some of them unidentified. Although it is possible through various measures to minimize these emissions, it is impossible to avoid them completely in the case of organic binders. In the case of inorganic-organic hybrid systems too, which, like the binders used, for example, in the Resol CO₂ method, contain a proportion of organic compounds, such undesired emissions occur in the course of casting of the metals.

In order to prevent the emission of decomposition products during the casting operation, it is necessary to use binders which are based on inorganic materials or which contain at most a very small proportion of organic compounds. Such binder systems have already been known for some time. Binder systems which harden as a result of introduction of gases have been developed. Such a system is described, for example, in GB 782 205, in which an alkali metal waterglass is used as the binder, which can be hardened by introduction of CO₂. DE 199 25 167 describes an exothermic feeder material which comprises an alkali metal silicate as a binder. In addition, binder systems which are self-curing at room temperature have been developed. Such a system based on phosphoric acid and metal oxides is described, for example, in U.S. Pat. No. 5,582,232. Finally, inorganic binder systems which are hardened at higher temperatures, for example in a hot mold, are also known. Such hot-hardening binder systems are known, for example, from U.S. Pat. No. 5,474,606, in which a binder system consisting of alkali metal waterglass and aluminum silicate is described.

However, inorganic binders also have disadvantages compared to organic binders. For example, the casting molds produced with waterglass as a binder have a relatively low strength. This leads to problems especially when the casting mold is removed from the mold, since the casting mold can break up. Good strengths at this time are particularly important for the production of complicated, thin-wall moldings and the safe handling thereof. The reason for the low strengths is primarily that the casting molds still contain residual water from the binder. Longer residence times in the hot closed mold are helpful only to a limited degree, since the water vapor cannot escape to a sufficient degree. In order to achieve maximum drying of the casting molds, WO 98/06522 proposes leaving the molding material mixture after demolding in a heated core box only until a dimensionally stable and portable edge shell forms. After the core box has been opened, the mold is removed and then dried completely under the action of microwaves. However, the additional drying is costly, prolongs the production time of the casting molds and makes a considerable contribution, not least through the energy costs, to making the production process more expensive.

A further weakness of the inorganic binders known to date is the low stability of the casting molds thus produced to high air humidity. This means that storage of the moldings over a prolonged period, as is customary for organic binders, is not reliably possible.

Casting molds produced with waterglass as a binder often exhibit poor decomposition after metal casting. Especially when the waterglass has been hardened by treatment with carbon dioxide, the binder can vitrify under the influence of the hot metal, such that the casting mold becomes very hard and can be removed from the casting only with a high level of cost and inconvenience. Attempts have therefore been made to add to the molding material mixture organic components which burn under the influence of the hot metal and, through the formation of pores, facilitate decomposition of the casting mold after casting.

DE 2 059 538 describes core sand and molding sand mixtures which comprise sodium silicate as a binder. In order to obtain improved decomposition of the casting mold after metal casting, glucose syrup is added to the mixture. The molding sand mixture processed to a casting mold is set by passing carbon dioxide gas through. The molding sand mixture contains 1 to 3% by weight of glucose syrup, 2 to 7% by weight of an alkali metal silicate and a sufficient amount of a core sand or molding sand. In the examples, it was found that molds and cores which contained glucose syrup have much better decomposition properties than molds and cores which contain sucrose or pure dextrose.

EP 0 150 745 A2 describes a binder mixture for solidification of molding sand, which consists of an alkali metal silicate, preferably sodium silicate, a polyhydric alcohol and further additives, the additives provided being modified carbohydrates, nonhygroscopic starch, a metal oxide and a filler. The modified carbohydrate used is a nonhygroscopic starch hydrolyzate with a reduction power of 6 to 15%, which can be added as a powder. The nonhygroscopic starch and the metal oxide, preferably iron oxide, are added to the amount of sand in an amount of 0.25 to 1% by weight. A lubricant in powder form or as an oil can optionally be added to the binder mixture. The binder mixture is preferably hardened by the use of CO₂ or of a chemical catalyst.

GB 847,477 describes a binder composition for the production of casting molds, which comprises an alkali metal silicate with an SiO₂/M₂O modulus of 2.0 to 3.22 and a polyhydroxyl compound. To produce casting molds, the binder is mixed with a refractory molding matrix and, after the production of the mold, hardened by sparging with carbon dioxide. The polyhydroxyl compounds used are, for example, mono-, di-, tri- or tetrasaccharides, no high demands being made on the purity of these compounds.

GB 902,199 describes a molding material mixture for the production of casting molds, which, as well as a refractory molding matrix, comprises a binder composition which comprises a mixture of 100 parts of a size obtained from cereal, 2 to 20 parts of sugar and 2 to 20 parts of a halogen acid or of a salt of a halogen acid. A suitable salt is, for example, ammonium chloride. The size is produced by partly hydrolyzing starch. To produce a casting mold, the molding material mixture is first converted to the desired form and then heated to a temperature of at least 175-180° C.

GB 1 240 877 describes a molding material mixture for the production of casting molds, which, as well as a refractory molding matrix, comprises an aqueous binder which, as well as an alkali metal silicate, comprises an oxidizing agent compatible with the alkali metal silicate and, based on the solution, 9 to 40% by weight of a readily oxidizable organic material. The oxidizing agents used may, for example, be nitrates, chromates, dichromates, permanganates or chlorates of the alkali metals. The readily oxidizable materials used may, for example, be starch, dextrins, cellulose, hydrocarbons, synthetic polymers such as polyethers or polystyrene, and hydrocarbons such as tar. The molding material mixture can be hardened by heating or by sparging with carbon dioxide.

U.S. Pat. No. 4,162,238 describes a molding material mixture for the production of casting molds, which, as well as a refractory molding matrix, comprises a binder based on an alkali metal silicate, especially waterglass. Amorphous silicon dioxide is added to the binder in an amount which, based on the solution of the binder, corresponds to 2 to 75%. The amorphous silicon dioxide has a particle size in the range from about 2 to 500 nm. In addition, the binder possesses an SiO₂:M₂O modulus of 3.5 to 10, where M is an alkali metal.

Owing to the above-discussed problem of the harmful emissions which occur in the course of casting, efforts are being made to replace the organic binders with inorganic binders in the production of casting molds, even in the case of complicated geometries. However, even in the case of complicated casting molds, sufficient strength of the casting mold even in thin-wall sections has to be ensured both immediately after the production when removed from the mold and in the course of metal casting. The strength of the casting mold should not worsen significantly during storage. The casting mold must therefore have sufficient stability to air humidity. Moreover, the casting should not require excessive further processing of the surface after production. The further processing of castings requires a high level of time, manpower and material, and therefore constitutes a significant cost factor in production. As early as immediately after removal from the casting mold, the casting should therefore already have a high surface quality.

It was therefore an object of the invention to provide a molding material mixture for production of casting molds for metalworking, which comprises at least one refractory molding matrix and a waterglass-based binder system, said molding material mixture comprising a proportion of a particulate metal oxide which is selected from the group of silicon dioxide, aluminum oxide, titanium oxide and zinc oxide, which enables the production of casting molds with complex geometry and which may also include, for example, thin-wall sections, and the casting obtained after metal casting should already have a high surface quality.

This object is achieved by a molding material mixture having the features of claim 1. Advantageous developments of the inventive molding material mixture are the subject of the dependent claims.

It has been found that, surprisingly, the addition of carbohydrates to the molding material mixture makes it possible to produce casting molds based on inorganic binders, which have a high strength both immediately after production and in the course of prolonged storage. Moreover, after metal casting, a casting with very high surface quality is obtained, such that, after the removal of the casting mold, only minor further processing of the surface of the casting is required. This is a significant advantage, since it is possible in this way to significantly lower the costs for the production of a casting. In the course of casting, compared to other organic additives, such as acrylic resins, polystyrene, polyvinyl esters or polyalkyl compounds, significantly lower evolution of smoke is observed, such that the workplace exposure for employees can be reduced significantly.

The inventive molding material mixture for production of casting molds for metalworking comprises at least:
a refractory molding matrix;
a waterglass-based binder; and
a proportion of a particulate metal oxide which is selected from the group of silicon dioxide, aluminum oxide, titanium oxide and zinc oxide.

According to the invention, the molding material mixture comprises a carbohydrate as a further constituent.

The refractory molding matrices used for the production of casting molds may be customary materials. The refractory molding matrix must have sufficient dimensional stability at the temperatures existing in metal casting. A suitable refractory molding matrix is therefore notable for a high melting point. The melting point of the refractory molding matrix is preferably higher than 700° C., more preferably higher than 800° C., particularly preferably higher than 900° C. and especially higher than 1000° C. Suitable refractory molding matrices are, for example, quartz sand or zirconium sand. In addition, fibrous refractory molding matrices are also suitable, for example schamotte fibers. Further suitable refractory molding matrices are, for example, olivine, chrome ore sand, vermiculite.

In addition, the refractory molding matrices used may also be synthetic refractory molding matrices, for example hollow aluminum silicate spheres (so-called microspheres), glass beads, glass pellets or spherical ceramic molding matrices known under the name “Cerabeads®” or “Carboaccucast®”. These synthetic refractory molding matrices are produced synthetically or are obtained, for example, as waste in industrial processes. These spherical ceramic molding matrices comprise, as minerals, for example, mullite, corundum, β-cristobalite in various proportions. They contain, as essential components, aluminum oxide and silicon dioxide. Typical compositions contain, for example, Al₂O₃ and SiO₂ in approximately identical proportions. In addition, further constituents may also be present in proportions of <10%, such as TiO₂, Fe₂O₃. The diameter of the spherical refractory molding matrices is preferably less than 1000 μm, especially less than 600 μm. Also suitable are synthetic refractory molding matrices, for example mullite (x Al₂O₃.y SiO₂, where x=2 to 3, y=1 to 2; ideal formula: Al₂SiO₅). These synthetic molding matrices do not derive from a natural origin and may also have been subjected to a special shaping method, as, for example, in the production of hollow aluminum silicate microspheres, glass beads or spherical ceramic molding matrices. Hollow aluminum silicate microspheres form, for example, in the course of combustion of fossil fuels or other combustible materials and are removed from the ash arising from the combustion. Hollow microspheres, as a synthetic refractory molding matrix, feature a low specific weight. This originates from the structure of these synthetic refractory molding matrices, which comprise gas-filled pores. These pores may be open or closed. Preference is given to using closed-pore synthetic refractory molding matrices. In the case of use of open-pore synthetic refractory molding matrices, a portion of the waterglass-based binder is absorbed into the pores and can then no longer display any binding action.

In one embodiment, the synthetic molding matrices used are glass materials. These are used especially in the form of glass spheres or as glass pellets. The glasses used may be customary glasses, preference being given to glasses having a high melting point. Suitable examples are glass beads and/or glass pellets which are produced from broken glass. Borate glasses are likewise suitable. The composition of such glasses is shown by way of example in the table which follows.

TABLE
Composition of glasses

| Constituent | Crushed glass | Borate glass |
|---|---|---|
| SiO₂ | 50-80% | 50-80% |
| Al₂O₃ | 0-15% | 0-15% |
| Fe₂O₃ | <2% | <2% |
| M^{II}O | 0-25% | 0-25% |
| M^{I}₂O | 5-25% | 1-10% |
| B₂O₃ | | <15% |
| Others | <10% | <10% |

M^{II}: alkaline earth metal, e.g. Mg, Ca, Ba
M^{I}: alkali metal, e.g. Na, K

In addition to the glasses listed in the table, it is, however, also possible to use other glasses whose content of the abovementioned compounds is outside the ranges specified. Equally, it is also possible to use specialty glasses which, as well as the oxides mentioned, also contain other elements or oxides thereof.

The diameter of the glass spheres is preferably 1 to 1000 μm, preferably 5 to 500 μm and more preferably 10 to 400 μm.

Preferably, merely a portion of the refractory molding matrix is constituted by glass materials. The proportion of the glass material in the refractory molding matrix is preferably selected lower than 35% by weight, more preferably lower than 25% by weight, especially preferably lower than 15% by weight.

In casting tests with aluminum, it was found that, when synthetic molding matrices are used, in particular in the case of glass beads, glass pellets or glass microspheres, a smaller amount of molding sand remains adhering on the metal surface after casting than when pure quartz sand is used. The use of such synthetic molding matrices based on glass materials therefore enables smooth cast surfaces to be obtained, in which case complicated aftertreatment by abrasive blasting is required at least to a considerably lesser degree, if at all.

In order to obtain the described effect of obtaining smooth cast surfaces, the proportion of glass material in the refractory molding matrix is preferably selected greater than 0.5% by weight, more preferably greater than 1% by weight, particularly preferably greater than 1.5% by weight, especially preferably greater than 2% by weight.

It is not necessary to form the entire refractory molding matrix from the synthetic refractory molding matrices. The preferred proportion of the synthetic molding matrices is at least about 3% by weight, more preferably at least 5% by weight, especially preferably at least 10% by weight, preferably at least about 15% by weight, more preferably at least about 20% by weight, based on the total amount of the refractory molding matrix. The refractory molding matrix is preferably in a free-flowing state, such that the inventive molding material mixture can be processed in customary core shooting machines.

For reasons of cost, the proportion of the synthetic refractory molding matrices is kept low. Preferably, the proportion of the synthetic refractory molding matrices in the refractory molding matrix is less than 80% by weight, preferably less than 75% by weight, more preferably less than 65% by weight.

As a further component, the inventive molding material mixture comprises a waterglass-based binder. The waterglasses used may be customary waterglasses as have already been used to date as binders in molding material mixtures. These waterglasses contain dissolved sodium silicates or potassium silicates and can be prepared by dissolving glasslike potassium silicates and sodium silicates in water. The waterglass preferably has an SiO₂/M₂O modulus in the range from 1.6 to 4.0, especially 2.0 to 3.5, where M is sodium and/or potassium. The waterglasses preferably have a solids content in the range from 30 to 60% by weight. The solids content is based on the amount of SiO₂ and M₂O present in the waterglass.

In addition, the molding material mixture contains a proportion of a particulate metal oxide which is selected from the group of silicon dioxide, aluminum oxide, titanium dioxide and zinc oxide. The average primary particle size of the particulate metal oxide may be between 0.10 μm and 1 μm. Owing to the agglomeration of the primary particles, however, the particle size of the metal oxides is preferably less than 300 μm, more preferably less than 200 μm, especially preferably less than 100 μm. It is preferably in the range from 5 to 90 μm, especially preferably 10 to 80 μm and most preferably in the range from 15 to 50 μm. The particle size can be determined, for example, by sieve analysis. More preferably, the sieve residue on a sieve with a mesh size of 63 μm is less than 10% by weight, preferably less than 8% by weight.

Particular preference is given to using silicon dioxide as the particulate metal oxide, particular preference being given here to synthetic amorphous silicon dioxide.

The particulate silicon dioxide used is preferably precipitated silica and/or fumed silica. Precipitated silica is obtained by reaction of an aqueous alkali metal silicate solution with mineral acids. The precipitate obtained is then removed, dried and ground. Fumed silicas are understood to mean silicas which are obtained at high temperatures by coagulation from the gas phase. Fumed silica can be produced, for example, by flame hydrolysis of silicon tetrachloride or in a light arc furnace by reduction of quartz sand with coke or anthracite to give silicon monoxide gas with subsequent oxidation to give silicon dioxide. The fumed silicas produced by the light arc furnace method may also comprise carbon. Precipitated silica and fumed silica are equally suitable for the inventive molding material mixture. These silicas are referred to hereinafter as “synthetic amorphous silicon dioxide”.

The inventors assume that the strongly alkaline waterglass can react with the silanol groups arranged on the surface on the synthetic amorphous silicon dioxide, and that, on evaporation of the water, a strong bond is established between the silicon dioxide and the waterglass which is then solid.

As a further essential component, the inventive molding material mixture comprises a carbohydrate. It is possible to use either mono- or disaccharides, or high molecular weight oligo- or polysaccharides. The carbohydrates can be used either as a single compound or as a mixture of different carbohydrates. No excessive requirements per se are made on the purity of the carbohydrates used. It is sufficient when the carbohydrates, based on the dry weight, are present in a purity of more than 80% by weight, especially preferably more than 90% by weight, especially preferably more than 95% by weight, based in each case on the dry weight. The monosaccharide units of the carbohydrates may be joined as desired in principle. The carbohydrates preferably have a linear structure, for example an α- or β-glycosidic 1,4 linkage. However, the carbohydrates may also entirely or partly have 1,6 linkage, for example amylopectin which has up to 6% α-1,6 bonds.

The amount of the carbohydrate is preferably selected at a relatively low level. In principle, the desire is to keep the proportion of organic components in the molding material mixture to a minimum, such that the evolution of smoke caused by the thermal decomposition of these organic compounds is as far as possible suppressed. Therefore, relatively small amounts of carbohydrate are added to the molding material mixture, in which case a significant improvement in the strength of the casting molds before casting or a significant improvement in the quality of the surface of the casting can be observed. Preferably, the proportion of the carbohydrate, based on the refractory molding matrix, is selected greater than 0.01% by weight, preferably greater than 0.02% by weight, more preferably greater than 0.05% by weight. A high proportion of carbohydrate does not bring about any further improvement in the strength of the casting mold or in the surface quality of the casting. Preferably, the amount of the carbohydrate, based on the refractory molding matrix, is selected less than 5% by weight, preferably less than 2.5% by weight, more preferably less than 0.5% by weight, especially preferably less than 0.4% by weight. For industrial application, small proportions of carbohydrates in the region of more than 0.1% by weight lead to clear effects. For industrial application, the proportion of the carbohydrate in the molding material mixture, based on the refractory molding matrix, is preferably in the range from 0.1 to 0.5% by weight, preferably 0.2 to 0.4% by weight. At proportions of more than 0.5% by weight of carbohydrate, no further significant improvement in the properties is achieved, and so amounts of more than 0.5% by weight of carbohydrate are not required per se.

In a further embodiment of the invention, the carbohydrate is used in underivatized form. Such carbohydrates can conveniently be obtained from natural sources, such as plants, for example cereals or potatoes. The molecular weight of such carbohydrates obtained from natural sources can be lowered, for example, by chemical or enzymatic hydrolysis, in order, for example, to improve the solubility in water. In addition to underivatized carbohydrates, which are thus formed only from carbon, oxygen and hydrogen, it is, however, also possible to use derivatized carbohydrates in which a portion or all hydroxyl groups have been etherified with, for example, alkyl groups. Suitable derivatized carbohydrates are, for example, ethylcellulose or carboxymethylcellulose.

In principle, it is possible to use hydrocarbons which are already low in molecular weight, such as mono- or disaccharides. Examples are glucose or sucrose. The advantageous effects are, however, observed especially when oligo- or polysaccharides are used. Particular preference is therefore given to using an oligo- or polysaccharide as the carbohydrate.

It is preferred in this context that the oligo- or polysaccharide has a molar mass in the range from 1000 to 100 000 g/mol, preferably 2000 to 30 000 g/mol. Especially when the carbohydrate has a molar mass in the range from 5000 to 20 000 g/mol, a significant increase in the strength of the casting mold is observed, such that the casting mold can be removed readily from the mold in the course of production and transported. Even in the case of prolonged storage, the casting mold exhibits a very good strength, such that storage of casting molds, which is required for mass production of castings, is also immediately possible over several days with ingress of air humidity. The stability under the action of water, as is unavoidable, for example, when applying a size to the casting mold, is also very good.

The polysaccharide is preferably formed from glucose units, which are especially preferably α- or β-glycosidically 1,4 bonded. However, it is also possible to use carbohydrate compounds which, as well as glucose, contain other monosaccharides, for instance galactose or fructose, as the inventive additive. Examples of suitable carbohydrates are lactose (α- or β-1,4-bonded disaccharide of galactose and glucose) and sucrose (disaccharide of α-glucose and βfructose).

The carbohydrate is more preferably selected from the group of cellulose, starch and dextrins, and derivatives of these carbohydrates. Suitable derivatives are, for example, derivatives etherified completely or partially with alkyl groups. However, it is also possible to perform other derivatizations, for example esterifications with inorganic or organic acids.

A further optimization of the stability of the casting mold and of the surface of the casting can be achieved when specific carbohydrates and in this context especially preferably starches, dextrins (hydrolyzate product of the starches) and derivatives thereof are used as the additive for the molding material mixture. The starches used may especially be the naturally occurring starches, for instance potato starch, corn starch, rice starch, pea starch, banana starch, horse chestnut starch or wheat starch. However, it is also possible to use modified starches, for example pregelatinized starch, thin-boiling starch, oxidized starch, citrate starch, acetate starch, starch ethers, starch esters or else starch phosphates. There is in principle no restriction in the selection of the starch. The starch may have, for example, low viscosity, moderate viscosity or high viscosity, and be cationic or anionic, and cold water-soluble or hot water-soluble. The dextrin is especially preferably selected from the group of potato dextrin, corn dextrin, yellow dextrin, white dextrin, borax dextrin, cyclodextrin and maltodextrin.

Especially in the case of production of casting molds with very thin-wall sections, the molding material mixture preferably additionally comprises a phosphorus compound. It is possible in principle to use either organic or inorganic phosphorus compounds. In order not to trigger any undesired side reactions in the course of metal casting, it is also preferred that the phosphorus in the phosphorus compounds is preferably present in the V oxidation state. The use of phosphorus compounds can further enhance the stability of the casting mold. This is of great significance especially when the liquid metal hits an oblique surface in the course of metal casting and exerts a high erosive action there owing to the high metallostatic pressure or can lead to deformations especially of thin-wall sections of the casting mold.

The phosphorus compound is preferably present in the form of a phosphate or phosphorus oxide. The phosphate may be present as an alkali metal phosphate or as an alkaline earth metal phosphate, particular preference being given to alkali metal phosphates and here especially to the sodium salts. In principle, it is also possible to use ammonium phosphates or phosphates of other metal ions. The alkali metal or alkaline earth metal phosphates mentioned as preferred are, however, readily obtainable and available inexpensively in unlimited amounts in principle. Phosphates of polyvalent metal ions, especially of trivalent metal ions, are not preferred. It has been observed that, when such phosphates of polyvalent metal ions, especially of trivalent metal ions, are used, the processing time of the molding material mixture is shortened.

When the phosphorus compound is added to the molding material mixture in the form of a phosphorus oxide, the phosphorus oxide is preferably present in the form of phosphorus pentoxide. However, it is also possible to use phosphorus trioxide and phosphorus tetroxide.

In a further embodiment, the phosphorus compound can be added to the molding material mixture in the form of salts of fluorophosphoric acids. Particular preference is given in this context to the salts of monofluorophosphoric acid. The sodium salt is especially preferred.

In a preferred embodiment, the phosphorus compounds added to the molding material mixture are organic phosphates. Preference is given here to alkyl phosphates or aryl phosphates. The alkyl groups comprise preferably 1 to 10 carbon atoms and may be straight-chain or branched. The aryl groups comprise preferably 6 to 18 carbon atoms, where the aryl groups may also be substituted by alkyl groups. Particular preference is given to phosphate compounds which derive from monomeric or polymeric carbohydrates, for instance glucose, cellulose or starch. The use of a phosphorus-containing organic component as an additive is advantageous in two aspects. Firstly, the phosphorus content can achieve the necessary thermal stability of the casting mold, and, secondly, the organic component positively influences the surface quality of the corresponding casting.

The phosphates used may be either orthophosphates or polyphosphates, pyrophosphates or metaphosphates. The phosphates can be prepared, for example, by neutralizing the appropriate acid with an appropriate base, for example an alkali metal base such as NaOH, or else optionally an alkaline earth metal base, though not all negative charges of the phosphate ion need necessarily be saturated by metal ions. It is possible to use either the metal phosphates or the metal hydrogenphosphates, or else the metal dihydrogenphosphates, for example Na₃PO₄, Na₂HPO₄ and NaH₂PO₄. Equally, it is possible to use the anhydrous phosphates, or else the hydrates of the phosphates. The phosphates can be introduced into the molding material mixture either in crystalline form or in amorphous form.

Polyphosphates are understood to mean especially linear phosphates which comprise more than one phosphorus atom, in which case the phosphorus atoms are each bonded via oxygen bridges. Polyphosphates are obtained by condensation of orthophosphate ions with elimination of water, so as to obtain a linear chain of PO₄ tetrahedra which are each joined via corners. Polyphosphates have the general formula (O(PO₃)ₙ)⁽ⁿ⁺²⁾⁻ where n corresponds to the chain length. A polyphosphate may comprise up to several hundred PO₄ tetrahedra. Preference is given, however, to using polyphosphates with shorter chain lengths. n preferably has values of 2 to 100, especially preferably 5 to 50. It is also possible to use more highly condensed polyphosphates, i.e. polyphosphates in which the PO₄ tetrahedra are joined to one another via more than two corners and therefore exhibit polymerization in two or three dimensions.

Metaphosphates are understood to mean cyclic structures which are formed from PO₄ tetrahedra which are each joined via corners. Metaphosphates have the general formula ((PO₃)ₙ)ⁿ⁻ where n is at least 3. n preferably has values of 3 to 10.

It is possible to use either individual phosphates or mixtures of different phosphates and/or phosphorus oxides.

The preferred proportion of the phosphorus compound, based on the refractory molding matrix, is between 0.05 and 1.0% by weight. In the case of a proportion of less than 0.05% by weight, no clear influence on the molding stability of the casting mold can be found. When the proportion of the phosphate exceeds 1.0% by weight, the hot stability of the casting mold decreases significantly. The proportion of the phosphorus compound is preferably selected between 0.10 and 0.5% by weight. The phosphorus compound contains preferably between 0.5 and 90% by weight of phosphorus, calculated as P₂O₅. When inorganic phosphorus compounds are used, they preferably contain 40 to 90% by weight, especially preferably 50 to 80% by weight, of phosphorus, calculated as P₂O₅. When organic phosphorus compounds are used, they preferably contain 0.5 to 30% by weight, especially preferably 1 to 20% by weight, of phosphorus, calculated as P₂O₅.

The phosphorus compound can in principle be added to the molding material mixture in solid or dissolved form. The phosphorus compound is preferably added to the molding material mixture as a solid. When the phosphorus compound is added in dissolved form, water is preferred as the solvent.

As a further advantage of an addition of phosphorus compounds to molding material mixtures to produce casting molds, it has been found that the molds exhibit very good decomposition after metal casting. This is true of metals which require low casting temperatures, such as light metals, especially aluminum. However, better decomposition of the casting mold has also been found in iron casting. In iron casting, higher temperatures of more than 1200° C. act on the casting mold, and so there is an increased risk of vitrification of the casting mold and hence of deterioration of the decomposition properties.

In the course of studies of the stability and of the decomposition of casting molds conducted by the inventors, iron oxide was also considered as a possible additive. In the case of addition of iron oxide to the molding material mixture, an enhancement in the stability of the casting mold in metal casting is likewise observed. The addition of iron oxide thus potentially likewise allows the stability of thin-wall sections of the casting mold to be improved. However, the addition of iron oxide does not bring about the improvement, observed in the case of addition of phosphorus compounds, in the decomposition properties of the casting mold after metal casting, especially iron casting.

The inventive molding material mixture constitutes an intensive mixture of at least the constituents mentioned. The particles of the refractory molding matrix are preferably coated with a layer of a binder. Evaporation of the water present in the binder (approx. 40-70% by weight, based on the weight of the binder) can then achieve firm cohesion between the particles of the refractory molding matrix.

The binder, i.e. the waterglass and the particulate metal oxide, especially synthetic amorphous silicon dioxide, and the carbohydrate is present in the molding material mixture preferably in a proportion of less than 20% by weight, especially preferably within a range from 1 to 15% by weight. The proportion of the binder is based on the solids content of the binder. When solid refractory molding matrices are used, for example quartz sand, the binder is preferably present in a proportion of less than 10% by weight, preferably less than 8% by weight, especially preferably less than 5% by weight. When refractory molding matrices which have a low density are used, for example the above-described hollow microspheres, the proportion of the binder is increased correspondingly.

The particulate metal oxide, especially the synthetic amorphous silicon dioxide, is present, based on the total weight of the binder, preferably in a proportion of 2 to 80% by weight, preferably between 3 and 60% by weight, especially preferably between 4 and 50% by weight.

The ratio of waterglass to particulate metal oxide, especially synthetic amorphous silicon dioxide, may be varied within wide ranges. This offers the advantage of improving the starting strength of the casting mold, i.e. the strength immediately after removal from the hot mold, and the moisture stability, without significantly influencing the final strengths, i.e. the strengths after the cooling of the casting mold, compared to a waterglass binder without amorphous silicon dioxide. This is of great interest in light metal casting in particular. On the one hand, high starting strengths are desired in order to be able to transport the casting mold without any problem after the production thereof or combine it with other casting molds. On the other hand, the final strength after the hardening should not be too high, in order to avoid difficulties in the course of binder decomposition after the casting, i.e. the molding matrix should be removable without any problem from cavities of the casting mold after the casting.

In one embodiment of the invention, the molding matrix present in the inventive molding material mixture may comprise at least a proportion of hollow microspheres. The diameter of the hollow microspheres is normally within the range from 5 to 500 μm, preferably within the range from 10 to 350 μm, and the thickness of the shell is usually within the range from 5 to 15% of the diameter of the microspheres. These microspheres have a very low specific weight, such that the casting molds produced using hollow microspheres have a low weight. The insulating action of the hollow microspheres is particularly advantageous. The hollow microspheres are therefore used for the production of casting molds especially when they are to have an increased insulating action. Such casting molds are, for example, the feeders already described in the introduction, which act as a balancing reservoir and contain liquid metal, the intention being to keep the metal in a liquid state until the metal introduced into the hollow mold has solidified. Another field of application of casting molds which contain hollow microspheres is, for example, that of sections of a casting mold, which correspond to particularly thin-wall sections of the finished casting. The insulating action of the hollow microspheres ensures that the metal does not solidify prematurely in the thin-wall sections, thus blocking the pathways within the casting mold.

When hollow microspheres are used, the binder, caused by the low density of these hollow microspheres, is used preferably in a proportion within the range of preferably less than 20% by weight, especially preferably within the range from 10 to 18% by weight. The values are based on the solids content of the binder.

The hollow microspheres preferably have a sufficient thermal stability, such that they do not soften prematurely in the course of metal casting and lose their shape. The hollow microspheres consist preferably of an aluminum silicate. These hollow aluminum silicate microspheres preferably have a content of aluminum oxide of more than 20% by weight, but may also have a content of more than 40% by weight. Such hollow microspheres are traded, for example, by Omega Minerals Germany GmbH, Norderstedt, under the names Omega-Spheres® SG with an aluminum oxide content of approx. 28-33%, Omega-Spheres® WSG with an aluminum oxide content of approx. 35-39%, and E-Spheres® with an aluminum oxide content of approx. 43%. Corresponding products are obtainable from PQ Corporation (USA) under the name “Extendospheres®”.

In a further embodiment, hollow microspheres formed from glass are used as the refractory molding matrix.

In a preferred embodiment, the hollow microspheres consist of a borosilicate glass. The borosilicate glass has a proportion of boron, calculated as B₂O₃, of more than 3% by weight. The proportion of hollow microspheres is preferably selected less than 20% by weight, based on the molding material mixture. In the case of use of hollow borosilicate glass microspheres, preference is given to selecting a small proportion. This proportion is preferably less than 5% by weight, more preferably less than 3% by weight, and is especially preferably in the range from 0.01 to 2% by weight.

As already explained, the inventive molding material mixture, in a preferred embodiment, comprises at least a proportion of glass pellets and/or glass beads as the refractory molding matrix.

It is also possible to configure the molding material mixture as an exothermic molding material mixture which is suitable, for example, for the production of exothermic feeders. For this purpose, the molding material mixture comprises an oxidizable metal and a suitable oxidizing agent. Based on the total mass of the molding material mixture, the oxidizable metals preferably form a proportion of 15 to 35% by weight. The oxidizing agent is preferably added in an amount of 20 to 30% by weight, based on the molding material mixture. Suitable oxidizable metals are, for example, aluminum or magnesium. Suitable oxidizing agents are, for example, iron oxide or potassium nitrate.

Compared to binders based on organic solvents, binders which contain water give rise to a poorer free flow of the molding material mixture. The free flow of the molding material mixture can worsen further as a result of the addition of the particulate metal oxide. This means that molds with narrow passages and several bends are more difficult to fill. As a consequence, the casting molds have sections with insufficient compaction, which can in turn lead to miscasts in the casting operation. In an advantageous embodiment, the inventive molding material mixture comprises a proportion of a lubricant, preferably of a lubricant in platelet form, especially graphite, MoS₂, talc and/or pyrophillite. It has been found that, surprisingly, when such lubricants are added, especially graphite, it is also possible to produce complex molds with thin-wall sections, in which case the casting molds have a uniformly high density and stability throughout, such that essentially no miscasts are observed in the casting operation. The amount of the lubricant in platelet form added, especially graphite, is preferably 0.05% by weight to 1% by weight, based on the refractory molding matrix.

In addition to the constituents mentioned, the inventive molding material mixture may comprise further additives. For example, internal release agents can be added, which facilitate the detachment of the casting molds from the mold. Suitable internal release agents are, for example, calcium stearate, fatty acid esters, waxes, natural resins or specific alkyd resins. In addition, it is also possible add silanes to the inventive molding material mixture.

For instance, the inventive molding material mixture, in a preferred embodiment, comprises an organic additive which has a melting point in the range from 40 to 180° C., preferably 50 to 175° C., i.e. is solid at room temperature. Organic additives are understood to mean compounds whose molecular structure is formed predominantly from carbon atoms, i.e., for example, organic polymers. The addition of the organic additives allows the quality of the surface of the casting to be improved further. The mechanism of action of the organic additives has not been explained. Without wishing to be bound to this theory, however, the inventors assume that at least a portion of the organic additives burns in the course of the casting operation, thus forming a thin gas cushion between liquid metal and the molding matrix which forms the wall of the casting mold, and thus preventing a reaction between liquid metal and molding matrix. Moreover, the inventors assume that a portion of the organic additives, under the reducing atmosphere which exists in the course of casting, forms a thin layer of so-called lustrous carbon, which likewise prevents a reaction between metal and molding matrix. As a further advantageous effect, the addition of the organic additives can achieve an enhancement of the strength of the casting mold after hardening.

The organic additives are added preferably in an amount of 0.01 to 1.5% by weight, especially preferably 0.05 to 1.3% by weight, more preferably 0.1 to 1.0% by weight, based in each case on refractory molding material. In order to prevent excessive evolution of smoke during metal casting, the proportion of organic additives is preferably selected less than 0.5% by weight.

It has been found that, surprisingly, an improvement in the surface of the casting can be achieved with very different organic additives. Suitable organic additives are, for example, phenol-formaldehyde resins, for example novolacs, epoxy resins, for example bisphenol A epoxy resins, bisphenol F epoxy resins or epoxidized novolacs, polyols, for example polyethylene glycols or polypropylene glycols, polyolefins, for example polyethylene or polypropylene, copolymers of olefins such as ethylene or propylene and further comonomers such as vinyl acetate, polyamides, for example polyamide 6, polyamide 12 or polyamide 66, natural resins, for example balsam resin, fatty acids, for example stearic acid, fatty acid esters, for example cetyl palmitate, fatty acid amides, for example ethylenediaminebisstearamide, and metal soaps, for example stearates or oleates of mono- to trivalent metals. The organic additives may be present either as a pure substance or as a mixture of different organic compounds.

In a further preferred embodiment, the inventive molding material mixture comprises a proportion of at least one silane. Suitable silanes are, for example, aminosilanes, epoxysilanes, mercaptosilanes, hydroxysilanes, methacryloylsilanes, ureidosilanes and polysiloxanes. Examples of suitable silanes are γ-aminopropyltrimethoxysilane, γ-hydroxypropyltrimethoxy-silane, 3-ureidopropyltriethoxysilane, γ-mercaptopropyl-trimethoxysilane, γ-glycidoxypropyltrimethoxysilane, β-(3,4-epoxycyclohexyl)trimethoxysilane, 3-methacryloyloxypropyl-trimethoxysilane and N-β(aminoethyl)-γ-aminopropyltrimethoxy-silane.

Based on the particulate metal oxide, typically approx. 5-50% by weight of silane is used, preferably approx. 7-45% by weight, more preferably approx. 10-40% by weight.

In spite of the high strengths achievable with the inventive binder, the casting molds produced with the inventive molding material mixture, especially cores and molds, exhibit surprisingly good decomposition after the casting operation, especially in aluminum casting. As already explained, it has also been found that the inventive molding material mixture can be used to produce casting molds which also exhibit very good decomposition in the case of iron casting, such that the molding material mixture, after the casting operation, can immediately also be poured out of narrow and angled sections of the casting mold. The use of the moldings produced from the inventive molding material mixture is therefore not restricted to light metal casting. The casting molds are generally suitable for casting metals. Such metals are, for example, nonferrous metals, such as brass or bronzes, and ferrous metals.

The invention further relates to a process for producing casting molds for metalworking, wherein the inventive molding material mixture is used. The process according to the invention comprises the steps of:
producing the above-described molding material mixture;
molding the molding material mixture;
hardening the molded molding material mixture by heating the molded molding material mixture to obtain the hardened casting mold.

In the production of the inventive molding material mixtures, the procedure is generally to first initially charge the refractory molding matrix and then to add the binder with stirring. The waterglass and the particulate metal oxide, especially the synthetic amorphous silicon dioxide, and the carbohydrate can in principle be added in any desired sequence. The carbohydrate can be added in dry form, for example in the form of a starch powder. However, it is also possible to add the carbohydrate in dissolved form. Preference is given to aqueous solutions of the carbohydrate. The use of aqueous solutions is especially advantageous when they are already available in the form of a solution owing to the production process, as, for instance, in the case of glucose syrup. The solution of the carbohydrate can also be mixed with the waterglass before the addition to the refractory molding matrix. The carbohydrate is preferably added in solid form to the refractory molding matrix.

In a further embodiment, the carbohydrate can be introduced into the molding material mixture by enveloping an appropriate carrier, for example other additives or the refractory molding matrix, with a solution of the corresponding carbohydrate. The solvent used may be water or else an organic solvent. Preference is given, however, to using water as the solvent. For a better bond between carbohydrate shell and carrier and to remove the solvent, a drying step can be carried out after the coating. This can be done, for example, in a drying oven or under the action of microwave radiation.

The above-described additives can be added to the molding material mixture in any form. They can be metered in individually or else as a mixture. They may be added in the form of a solid, or else in the form of solutions, pastes or dispersions. When the addition is effected in solid, paste or dispersion form, water is preferred as the solvent. It is likewise possible to utilize the waterglass used as a binder as a solution or dispersion medium for the additives.

In a preferred embodiment, the binder is provided as a two-component system, in which case a first liquid component contains the waterglass and a second solid component the particulate metal oxide. The solid component may further comprise, for example, the phosphate and if appropriate a lubricant, preferably in platelet form. When the carbohydrate is added in solid form to the molding material mixture, it can likewise be added to the solid component.

In the production of the molding material mixture, the refractory molding matrix is initially charged in a mixer and then preferably first the solid component(s) of the binder is/are added and mixed with the refractory molding matrix. The mixing time is selected such that intimate mixing of refractory molding matrix and solid binder component proceeds. The mixing time depends on the amount of the molding mixture to be produced and on the mixing unit used. The mixing time is preferably selected between 1 and 5 minutes. With preferably further movement of the mixture, the liquid component of the binder is then added and then the mixture is mixed further until a homogeneous layer of the binder has formed on the grains of the refractory molding matrix. Here too, the mixing time depends on the amount of the molding material mixture to be produced and on the mixing unit used. The duration for the mixing operation is preferably selected between 1 and 5 minutes. A liquid component is understood to mean either a mixture of different liquid components or the entirety of all liquid individual components, in which case the latter can also be added individually. Equally, a solid component is understood to mean either the mixture of individual components or of all of the above-described solid components or the entirety of all solid individual components, in which case the latter can be added together or else successively to the molding material mixture.

In another embodiment, it is also possible first to add the liquid component of the binder to the refractory molding matrix only then to supply the solid component to the mixture. In a further embodiment, first 0.05 to 0.3% water, based on the weight of the molding matrix, is added to the refractory molding matrix and only then are the solid and liquid components of the binder added. In this embodiment, a surprising positive effect on the processing time of the molding material mixture can be achieved. The inventors assume that the water-removing action of the solid components of the binder is reduced in this way and the hardening operation is retarded as a result.

The molding material mixture is then introduced into the desired mold. Customary methods are used for the molding. For example, the molding material mixture can be shot into the mold by means of a core shooting machine with the aid of compressed air. The molding material mixture is subsequently hardened by supplying heat in order to evaporate the water present in the binder. In the course of heating, water is withdrawn from the molding material mixture. The withdrawal of water is also thought to initiate condensation reactions between silanol groups, such that crosslinking of the waterglass occurs. In cold hardening methods described in the prior art, for example, introduction of carbon dioxide or polyvalent metal cations brings about precipitation of sparingly soluble compounds and hence solidification of the casting mold.

The molding material mixture can be heated, for example, in the mold. It is possible to completely harden the casting mold actually within the mold. However, it is also possible to harden the casting mold only in its edge region, such that it has a sufficient strength to be removable from the mold. The casting mold can then subsequently be hardened fully by removing further water from it. This can done, for example, in an oven. The water can also be withdrawn, for example, by evaporating the water under reduced pressure.

The hardening of the casting molds can be accelerated by blowing heated air into the mold. In this embodiment of the process, rapid removal by transport of the water present in the binder is achieved, which solidifies the casting mold within periods suitable for industrial application. The temperature of the air blown in is preferably 100° C. to 180° C., especially preferably 120° C. to 150° C. The flow rate of the heated air is preferably adjusted such that hardening of the casting mold proceeds within periods suitable for industrial application. The periods depend on the size of the casting molds produced. What is desired is hardening within a period of less than 5 minutes, preferably less than 2 minutes. In the case of very large casting molds, however, longer periods may also be required.

The water can also be removed from the molding material mixture in such a way that the heating of the molding material mixture is brought about through injection of microwaves. However, the injection of microwaves is preferably undertaken once the casting mold has been removed from the mold. For this purpose, the casting mold must, however, already have sufficient strength. As already explained, this can be brought about, for example, by hardening at least an outer shell of the casting mold actually within the mold.

The thermal hardening of the molding material mixture with removal of water avoids the problem of subsequent reinforcement of the casting mold during metal casting. In the cold hardening method described in the prior art, in which carbon dioxide is passed through the molding material mixture, carbonates are precipitated out of the waterglass. In the hardened casting mold, however, a relatively large amount of water remains bound, which is then driven out in the course of metal casting and leads to very high solidification of the casting mold. Moreover, casting molds which have been solidified by introduction of carbon dioxide do not achieve the stability of casting molds which have been hardened thermally by removal of water. The formation of carbonates disrupts the structure of the binder, and it therefore loses strength. Cold-hardened casting molds based on waterglass therefore cannot be used to produce thin sections of a casting mold, which may also have a complex geometry. Casting molds which have been cold-hardened by introduction of carbon dioxide are therefore unsuitable for manufacture of castings with very complicated geometry and narrow passages with several bends, such as oil passages in internal combustion engines, since the casting mold does not achieve the required stability and the casting mold can be removed completely from the casting only with a very high level of cost and inconvenience after the metal casting. The thermal curing substantially removes the water from the casting mold, and significantly lower after-hardening of the casting mold is observed in the course of metal casting. After metal casting, the casting mold exhibits significantly better decomposition than casting molds which have been hardened by introduction of carbon dioxide. The thermal hardening makes it possible also to produce casting molds which are suitable for the manufacture of castings with very complex geometry and narrow passages.

As already explained above, the addition of lubricants, preferably in platelet form, especially graphite and/or MoS₂ and/or talc, improves the free flow of the inventive molding material mixture. Talc-like minerals, for instance pyrophyllite, can also improve the free flow of the molding material mixture. In the course of production, the lubricant in platelet form, especially graphite and/or talc, can be added to the molding material mixture separately from the two binder components. However, it is equally possible to premix the lubricant in platelet form, especially graphite, with the particulate metal oxide, especially the synthetic amorphous silicon dioxide, and only then to mix them with the waterglass and the refractory molding matrix.

In addition to the carbohydrate, the molding material mixture, as already described, may also comprise further organic additives. In principle, these further organic additives can be added at any time in the production of the molding material mixture. The organic additive can be added in bulk or else in the form of a solution. However, the amount of organic additives is preferably selected at a low level, especially preferably less than 0.5% by weight based on the refractory molding matrix. The total amount of organic additives, i.e. including the carbohydrate, is preferably selected less than 0.5% by weight, based on the refractory molding matrix.

Water-soluble organic additives can be used in the form of an aqueous solution. When the organic additives are soluble in the binder and are storage-stable therein without decomposition over several months, they can also be dissolved in the binder and thus added to the molding matrix together with the latter. Water-insoluble additives can be used in the form of a dispersion or of a paste. The dispersions or pastes preferably contain water as a dispersion medium. In principle, it is also possible to prepare solutions or pastes of the organic additives in organic solvents. However, when a solvent is used for the addition of the organic additives, preference is given to using water.

Preference is given to adding the organic additives as a powder or as short fibers, in which case the mean particle size or the fiber length is preferably selected such that it does not exceed the size of the refractory molding matrix particles. The organic additives can more preferably be sieved through a sieve of mesh size approx. 0.3 mm. In order to reduce the number of components added to the refractory molding matrix, the particulate metal oxide and the organic additive(s) are preferably not added separately to the molding sand, but are mixed beforehand.

When the molding material mixture comprises silanes or siloxanes, they are typically added in such a way that they are incorporated into the binder beforehand. The silanes or siloxanes can also be added to the molding matrix as a separate component. However, it is particularly advantageous to silanize the particulate metal oxide, i.e. to mix the metal oxide with the silane or siloxane, such that its surface is provided with a thin silane or siloxane layer. When the particulate metal oxide thus pretreated is used, increased stabilities and an improved resistance to high air humidity are found compared to the untreated metal oxide. When, as described, an organic additive is added to the molding material mixture or to the particulate metal oxide, it is appropriate to do this before the silanization.

The process according to the invention is suitable in principle for the production of all casting molds customary for metal casting, i.e., for example, of cores and molds. Particularly advantageously, it is also possible to produce casting molds which include very thin-wall sections. Especially in the case of addition of insulating refractory molding matrix or in the case of addition of exothermic materials to the inventive molding material mixture, the process according to the invention is suitable for producing feeders.

The casting molds produced from the inventive molding material mixture or with the process according to the invention have a high strength immediately after production, without the strength of the casting molds after hardening being so high that difficulties occur after the production of the casting in the removal of the casting mold. It has been found here that the casting mold has very good decomposition properties both in light metal casting, especially aluminum casting, and in iron casting. Moreover, these casting molds have a high stability in the case of elevated air humidity, i.e. the casting molds can surprisingly be stored without any problem even over a prolonged period. As particular advantage, the casting mold has a very high stability under mechanical stress, such that it is also possible to achieve thin-wall sections of the casting mold without them being deformed by the metallostatic pressure in the casting operation. The invention therefore further provides a casting mold which has been obtained by the above-described process according to the invention.

The inventive casting mold is suitable generally for metal casting, especially light metal casting. Particularly advantageous results are obtained in aluminum casting.

The invention is illustrated in detail hereinafter with reference to examples.

### EXAMPLE 1

Influence of synthetic amorphous silicon dioxide and various carbohydrates on the strength of moldings with quartz sand as the molding matrix.

### 1. Production and Testing of the Molding Material Mixture

For the testing of the molding material mixtures, Georg Fischer test bars were produced. Georg Fischer test bars are understood to mean cuboidal test bars of dimensions 150 mm×22.36 mm×22.36 mm.

The composition of the molding material mixture is given in Table 1. To produce the Georg Fischer test bars, the procedure was as follows:

The components listed in Table 1 were mixed in a laboratory blade mixer (from Vogel & Schemmann AG, Hagen, Germany). To this end, the quartz sand was initially charged and the waterglass was added with stirring. The waterglass used was a sodium waterglass which had potassium components. In the tables which follow, the modulus is therefore reported as SiO₂:M₂O where M represents the sum total of sodium and potassium. Once the mixture had been stirred for one minute, if appropriate, the amorphous silicon dioxide and/or the carbohydrate were added with further stirring. The mixture was subsequently stirred for a further minute.

The molding material mixtures were transferred into the reservoir bunker of an H 2,5 hot-box core shooting machine from Röperwerk—Gieβereimaschinen GmbH, Viersen, Germany, whose mold had been heated to 200° C.

The molding material mixtures were introduced into the mold by means of compressed air (5 bar) and remained in the mold for a further 35 seconds.

To accelerate the hardening of the mixtures, hot air (2 bar, 120° C. on entry into the mold) was passed through the mold during the last 20 seconds.

The mold was opened and the test bar was removed.

To determine the flexural strengths, the test bars were placed into a Georg Fischer strength tester equipped with a 3-point bending apparatus (DISA Industrie AG, Schaffhausen, Switzerland) and the force which led to the fracture of the test bar was measured.

The flexural strengths were measured according to the following scheme:
10 seconds after removal (hot strengths)
1 hour after removal (cold strengths)
storage of the cooled cores in a climate-controlled cabinet at 30° C. and 75% relative air humidity for 3 hours.

TABLE 1
Composition of the molding material mixtures

| | H32 | Alkali | Amorphous | | |
|---|---|---|---|---|---|
| | Quartz | metal | silicon | | |
| | sand | waterglass | dioxide | Carbohydrate | |
| 1.1 | 100 GT | 2.0 ^{a)} | | | Comparative, |
| | | | | | noninventive |
| 1.2 | 100 GT | 2.0 ^{a)} | 0.2 ^{b)} | | Comparative, |
| | | | | | noninventive |
| 1.3 | 100 GT | 2.0 ^{a)} | 0.5 ^{b)} | | Comparative, |
| | | | | | noninventive |
| 1.4 | 100 GT | 2.0 ^{a)} | | 0.2 ^{c)} | Comparative, |
| | | | | | noninventive |
| 1.5 | 100 GT | 2.0 ^{a)} | 0.5 ^{b)} | 0.2 ^{c)} | inventive |
| 1.6 | 100 GT | 2.0 ^{a)} | 0.5 ^{b)} | 0.2 ^{d)} | inventive |
| 1.7 | 100 GT | 2.0 ^{a)} | 0.5 ^{b)} | 0.2 ^{e)} | inventive |
| 1.8 | 100 GT | 2.0 ^{a)} | 0.5 ^{b)} | 0.1 ^{c)} | inventive |

^{a)} Alkali metal waterglass with SiO₂:M₂O modulus of approx. 2.3
^{b)} Elkem Microsilica 971 (fumed silica; produced in a light arc furnace)
^{c)} Yellow potato dextrin (from Cerestar), added in solid form
^{d)} Ethylcellulose (Ethocel ®, from Dow), added in solid form
^{e)} Potato starch derivative (Emdex GDH 43, from Emsland-Stärke GmbH), added in solid form

TABLE 2
Flexural strengths

| | | | After storage | |
|---|---|---|---|---|
| | | | in climate- | |
| | Hot | Cold | controlled | |
| | strengths | strengths | cabinet | |
| | [N/cm²] | [N/cm²] | [N/cm²] | |
| 1.1 | 80 | 420 | 10 | Comparative, |
| | | | | noninventive |
| 1.2 | 120 | 500 | 140 | Comparative, |
| | | | | noninventive |
| 1.3 | 170 | 520 | 190 | Comparative, |
| | | | | noninventive |
| 1.4 | 120 | 450 | 100 | Comparative, |
| | | | | noninventive |
| 1.5 | 200 | 580 | 320 | inventive |
| 1.6 | 140 | 400 | 250 | inventive |
| 1.7 | 180 | 450 | 250 | inventive |
| 1.8 | 180 | 460 | 210 | inventive |

### Result

### Influence of the Carbohydrate Added

Example 1.1 shows that, without addition of amorphous silicon dioxide or of a carbohydrate, sufficient hot strengths cannot be achieved. The storage stability of the cores produced with molding material mixture 1.1 also shows that mass core manufacture in a reliable process is not possible therewith. Addition of amorphous silicon dioxide allows the hot strengths to be enhanced (Examples 1.2 and 1.3), such that the cores possess sufficient strength for them to be processed further directly after core production. The addition of amorphous silicon dioxide improves the storage stability of the cores, especially at high relative air humidity. The addition of carbohydrate compounds, especially of dextrin compounds (Example 1.4) surprisingly leads, similarly to the case of the amorphous silicon dioxide, to an improvement in the hot strength. In addition, compared to molding material mixture 1.1, an improved storage stability of the cores produced is found. The combined addition of amorphous silicon dioxide and dextrin (Example 1.5) exhibits particularly high immediate strengths and a further-optimized storage stability. The final strengths are also significantly increased compared to the other mixtures. The use of ethylcellulose (Example 1.6) or of a potato starch derivative (Example 1.7) in combination with amorphous silicon dioxide likewise enables core production in a reliable process. An addition of only 0.1% potato dextrin (mixture 1.8) has a positive effect on the immediate strengths and the storage stability of the cores (compared to mixture 1.3)

### EXAMPLE 2

Influence of synthetic amorphous silicon dioxide and various carbohydrates on the cast surface of the castings produced with moldings of the abovementioned molding material mixture (Table 1).

Georg Fischer test bars of molding material mixtures 1.1 to 1.8 were incorporated into a sand casting mold in such a way that three of the four longitudinal sides become bonded to the cast metal during the casting process. Casting was effected with a type 226 aluminum alloy at a casting temperature of 735° C. After cooling of the casting mold, the casting was freed of the sand by means of high-frequency hammer blows. The castings were assessed with regard to the adhering sand remaining.

The casting section of mixture 1.1, just like those of mixtures 1.2 and 1.3, exhibited very significant adhering sand. The carbohydrate-containing molding material mixture (mixture 1.4) has a positive influence on the casting surface quality. The casting sections of mixtures 1.5, 1.6 and 1.7 likewise have barely any adhering sand, which confirms the positive influence of the carbohydrates (here in the form of dextrin and ethylcellulose) on the casting surface quality in these cases too. Even the addition of only 0.1% dextrin (mixture 1.8) brings about a significant improvement in the surface quality compared to the carbohydrate-free comparison (mixture 1.3).

1. A molding material mixture for production of casting molds for metalworking, comprising at least:
a refractory molding matrix;
a waterglass-based binder;
a proportion of a particulate metal oxide which is selected from the group consisting of silicon dioxide, aluminum oxide, titanium oxide and zinc oxide;
characterized in that a carbohydrate has been added to the molding material mixture.

2. The molding material mixture as claimed in claim 1, characterized in that the proportion of the carbohydrate, based on the refractory molding matrix, comprises from 0.01 to 5% by weight.

3. The molding material mixture as claimed in claim 1, characterized in that the carbohydrate comprises an oligosaccharide or polysaccharide.

4. The molding material mixture as claimed in claim 3, characterized in that the oligo- or polysaccharide has a molar mass within the range from 1000 to 100 000 g/mol.

5. The molding material mixture as claimed in claim 3, characterized in that the polysaccharide is formed from glucose units.

6. The molding material mixture as claimed in claim 1, characterized in that the carbohydrate is selected from the group consisting of cellulose, starch and dextrins, and derivatives of these carbohydrates.

7. The molding material mixture as claimed claim 1, characterized in that the carbohydrate comprises an underivatized carbohydrate.

8. The molding material mixture as claimed in claim 6, characterized in that the dextrin is selected from the group consisting of potato dextrin, corn dextrin, yellow dextrin, white dextrin, borax dextrin, cyclodextrin and maltodextrin.

9. The molding material mixture as claimed in claim 6, characterized in that the starch is selected from the group consisting of potato starch, corn starch, rice starch, pea starch, banana starch, horse chestnut starch or wheat starch.

10. The molding material mixture as claimed in claim 1, characterized in that a phosphorous compound has been added to the molding material mixture.

11. The molding material mixture as claimed in claim 10, wherein the phosphorus compound is selected from the group consisting of an orthophosphate, metaphosphate or polyphosphate.

12. The molding material mixture as claimed in claim 10, characterized in that the phosphorus compound comprises an organic phosphate which is derived from the group consisting of alkyl phosphates, aryl phosphates or carbohydrate-containing phosphates.

13. The molding material mixture as claimed in claim 10, characterized in that the proportion of the phosphorus compound, based on the refractory molding matrix, is selected between 0.05 and 1.0% by weight.

14. The molding material mixture as claimed in claim 10, characterized in that the phosphorus compound has a phosphorus content of 0.5 to 90% by weight, calculated as P₂O₅.

15. The molding material mixture as claimed in claim 1, characterized in that the particulate metal oxide is selected from the group consisting of precipitated silica and fumed silica.

16. The molding material mixture as claimed in claim 1, characterized in that the waterglass has an SiO₂/M₂O modulus in the range from 1.6 to 4.0, where M comprises sodium ions and/or potassium ions.

17. The molding material mixture as claimed in claim 1, characterized in that the waterglass has a solids content of SiO₂ and M₂O in the range from 30 to 60% by weight.

18. The molding material mixture as claimed in claim 1, characterized in that the binder is present in the molding material mixture in a proportion of less than 20% by weight.

19. The molding material mixture as claimed in claim 1, characterized in that the particulate metal oxide is present in a proportion of 2 to 80% by weight based on the binder.

20. The molding material mixture as claimed in claim 1, characterized in that the molding matrix comprises at least a proportion of hollow microspheres.

21. The molding material mixture as claimed in claim 20, characterized in that the hollow microspheres comprise hollow aluminum silicate microspheres and/or hollow glass microspheres.

22. The molding material mixture as claimed in claim 1, characterized in that the molding matrix comprises at least a proportion of one of the group consisting of glass pellets, glass beads and/or spherical ceramic moldings.

23. The molding material mixture as claimed in claim 1, characterized in that the molding matrix comprises at least a proportion of one of the group consisting of mullite, chrome ore sand and/or olivine.

24. The molding material mixture as claimed in claim 1, characterized in that an oxidizable metal and an oxidizing agent have been added to the molding material mixture.

25. The molding material mixture as claimed in claim 1, characterized in that the molding material mixture further comprises a proportion of a lubricant in platelet form.

26. The molding material mixture as claimed in claim 25, characterized in that the lubricant in platelet form is selected from the group consisting of graphite, molybdenum sulfide, talc and/or pyrophyllite.

27. The molding material mixture as claimed in claim 1, characterized in that the molding material mixture further comprises a proportion of at least one organic additive that is solid at room temperature.

28. The molding material mixture as claimed in claim 1, characterized in that the molding material mixture further comprises at least one silane or siloxane.

29. A process for producing casting molds for metalworking, comprising the steps of:
producing a molding material mixture as claimed in claim 1;
molding the molding material mixture;
hardening the molded molding material mixture by heating the molded molding material mixture to obtain a hardened casting mold.

30. The process as claimed in claim 29, characterized in that the molding material mixture is heated to a temperature in the range from 100 to 300° C.

31. The process as claimed in claim 29, characterized in that heated air is blown into the molded molding material mixture for hardening.

32. The process as claimed in claim 29, characterized in that the heating of the molding material mixture is brought about by the action of microwaves.

33. The process as claimed in claim 29, characterized in that the casting mold is a feeder.

34. A casting mold comprising the molding material mixture as claimed in claim 1.

35. (canceled)
